(19) United States
(12) Patent Application Publication
(10) Pub. No.: US 2003/0198527 A1
(43) Pub. Date: Oct. 23, 2003

(54) Load restraining device

(76) Inventor: Wally Galas, Victoria (AU)

Correspondence Address: Gerald T. Shekleton, Esq., Welsh & Katz, Ltd., 22nd Floor, 120 S. Riverside Plaza, Chicago, IL, 60606, US

(21) Appl. No.: 10/127,998

(22) Filed: Apr. 23, 2002

(51) Int. Cl. B60P 7/12

(52) U.S. Cl. 410/47

(57) ABSTRACT

A load restraining device particularly for restraining cylindrical or irregularly shaped loads during transit. The device comprising a plurality of members connected by a spacer or spacers and locatable about an upper edge of the load to be restrained; the members having upper and side sections with one or more abutments located on the upper section.

### FIELD OF THE INVENTION

The present invention relates to a load restraining device and related method. In particular, but not exclusively, the present invention relates to a device which can be utilised especially for restraining cylindrical or other irregular shaped but solid loads.

### FIELD OF THE INVENTION

Particular problems exist in attempting to safely transport solid loads which are cylindrical in shape or have other irregular shape as such loads are difficult to fasten onto transport vehicles, due to their shape. For example, in the case of square or rectangular shaped loads it is relatively simple to restrain the load on a vehicle tray or pellet or the like by using chain, strapping, cable or wire which passes over the load in two directions. However, in attempting to restrain solid loads of irregular shape or which are cylindrical problems arise due to the absence of straight edges against which a restraining device such as a chain, strap, wire, cable or rope can be affixed. In the example of cylindrical loads such as large rolls of paper or plastic material or coils of metal it is usual for the cylinder to be stacked upright on a pellet and then loaded onto the tray of a vehicle such as a truck, train, ship or aircraft, for transport purposes.

Up until the present time loads such as this have been secured simply by passing a securing means over the load and across its diameter which is then fastened to fastening points on either side of the load. Even though this may be conducted in two directions such that the securing means intersect at a right angle, it is still difficult to ensure adequate restraint of the load especially in situations when the vehicle bearing the load may brake or turn suddenly. Unfortunately, as a result of difficulties associated with securing irregular shaped solid or cylindrical loads there have been a number of accidents which have resulted in loss of life, injury and damage to equipment. Accordingly, there is a particular need for a means by which loads, particularly, but not exclusively cylindrical or irregular shaped loads, can be restrained during transport. It is with this background in mind that the present invention has been conceived.

Accordingly, it is an object of the present invention to provide a device useful in restraining loads during transport and to methods of using such a device. Other embodiments of the present invention will become apparent from the following detailed description thereof.

### SUMMARY OF THE INVENTION

According to one embodiment of the present invention there is a load restraining device comprising a plurality of members connected by a spacer or spacers and locatable about an upper edge of the load to be restrained; the members having upper and side sections with one or more abutments located on the upper section.

In one embodiment the device comprises a pair of members connected by a single spacer. In another embodiment the device comprises a pair of members connected by two spacers. Preferably the members have one or two abutments located on the upper section.

In one embodiment of the invention the distance between the members is fixed by the spacer or spacers. In another embodiment the spacer or spacers allow adjustable distance setting between the members.

In a preferred embodiment of the invention the spacer or spacers comprise chain connected to the members, and a releasable catch for varying spacer length.

According to a further embodiment of the present invention there is provided a method of restraining a load comprising locating a restraining device as outlined above about an upper edge of the load, fastening securing means to a first fastening point, passing the securing means over the load and against the abutments and fastening to a second securing point such that the securing means exert downward force on the load via the members and lateral force against the abutments.

In a preferred aspect of the invention the securing means is rope, strap, wire, cable or chain.

According to another embodiment of the invention there is provided a component of a load restraining device comprising a member locatable about an edge of a load to be restrained; the member having an upper and a side section, with one or more abutments located on the upper section and with one or more attachment means for connection to a spacer.

Preferably there are two abutments in this embodiment of the invention, located towards either end of the upper section.

In this embodiment of the invention there are preferably two attachment means for connection to spacers.

According to another embodiment of the invention there is provided a component of a load restraining device comprising a member locatable about an edge of a load to be restrained; the member having an upper and a side section, with two abutments each located at or towards ends of the upper section and with two means for connection to a spacer each located at or towards ends of the side section. Preferably the means for connection comprise hooks suitable for engaging between links of a spacer chain. It is also preferred that resilient material is located on surfaces of the member that in use will contact the load.

### BRIEF DESCRIPTION OF THE DRAWINGS

The present invention will now be described further, by way of example, with reference to the drawings wherein:

FIG. 1 shows a perspective view of the load restraining device according to the invention in position about the upper edge of a cylindrical load; and

FIG. 2 shows a perspective view of a cylindrical load being restrained with the use of the restraining device according to the invention on a pellet, which is located on the tray of a vehicle.

FIG. 3 shows a perspective view of a component of the load restraining device according to one embodiment of the invention.

### DETAILED DESCRIPTION OF THE INVENTION

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

In its broadest aspect the present invention simply comprises a plurality of members (preferably two to four, and most preferably two) which are locatable about the upper edge of a load to be restrained and which are connected by a spacer or spacers, with each of the members having an abutment located on an upper section thereof. The members will be produced from a strong, rigid material. Preferably the members will be produced from metal and particularly preferably from steel. The members comprise an upper section and a side section, with the upper section intended to be located above an upper surface of the load and the side section adjacent to a side surface of the load, about the load's upper edge. The side and upper sections are connected, for example about a 90° angle, although this angle may be varied according to the shape and dimensions of the load concerned. It is possible for the side and upper sections to be formed from a single piece of material which has been bent, moulded or shaped into the appropriate configuration, or alternatively from separate pieces of material which have been joined together, for example by welding.

In another embodiment of the invention the members may in fact be integral with the spacer so that the upper and side sections of each member continue and are fused into the other.

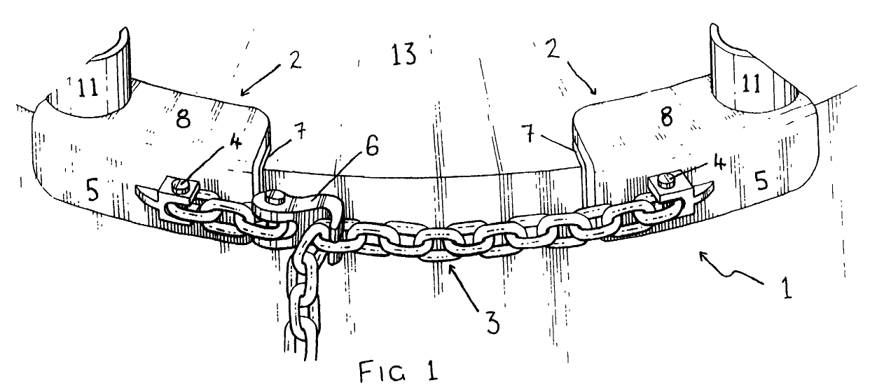

The spacer provides a connection between the members and serves to prevent their lateral movement away from one another, past a defined extent. The spacer may therefore constitute a piece of rigid material which locks the members in fixed position relative to one another or may constitute flexible material fused or otherwise joined to each of the members which will allow the movement of the members into closer proximity but not further apart, when in use. In a preferred embodiment of the invention the spacer constitutes a chain which is fixed at each end to one of the members, preferably, but not essentially, to the side section thereof. In a particularly preferred aspect of the invention, as demonstrated within FIG. 1, there is provided a releasable clamp within the chain which allows the length of the spacer to be varied. In another aspect of the invention one or more hooks or clasps which may lock between links of a chain may be attached or connected to the member, preferably at one or both ends of the side section.

On the upper section of each of the members is provided an abutment against which a securing means can be located to exert a downward and lateral force, in order to stabilise the load. In one form of the invention the abutment simply constitutes an upward projection from the upper section of each member. In other forms of the invention, however, the abutment may constitute a loop through which a securing means can pass or in fact the abutment may even take the form of a locking means which can lock the securing means into place about each member. There may in fact be more than one abutment located on the upper section of the member and in one embodiment there are two abutments which may be located one at each end of the upper section, or at least towards the ends. In a preferred embodiment of the invention the abutment/s do not have exposed edges, such that the possibility of tarpaulins or covers catching, and possibly being damaged on the abutment/s, is minimised.

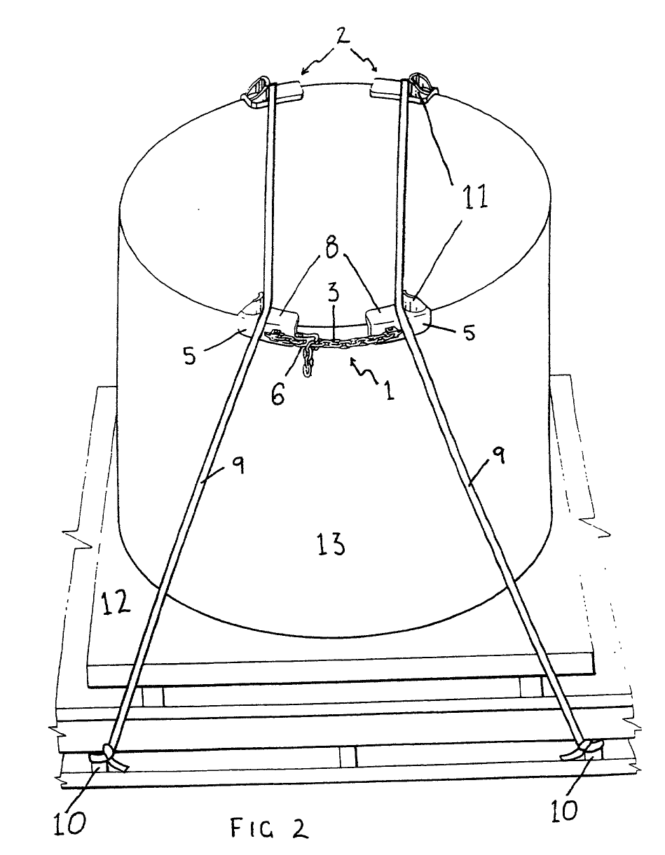

An example of the invention is demonstrated in FIGS. 1 and 2 where the load retaining device 1 constitutes two members 2 which are connected by the spacer 3 which takes the form of a chain. The members comprise upper 8 and side 5 sections, with an abutment 11 present on the upper section 8. The chain spacer 3 is attached to each of the members via an attachment means, in this instance taking the form of a bolt 4 fixed to the side sections 5 of the members 2. The bolt 4 receives a link from the chain spacer 3. The spacer 3 in this embodiment of the invention is also provided with a clasp 6 which can lock onto the chain spacer 3 between links of the chain in order to vary the length of the spacer 3 and consequently the distance between the members 2. This type of spacer arrangement enables the load retaining device 1 to be adapted for use in relation to loads of different size.

In the example of the invention shown in the figures the load is in a cylindrical form and the members 2 are configured such that the side sections 5 are curved to aid location about the outer surface of the load 13. The members 2 may be formed in different shapes to ensure compatibility with different shaped loads. For example, there may be instances when the load retaining device 1 according to the present invention may be utilised with a square or rectangular load and as such the members 2 could conveniently be shaped with a straight edge to fit about an upper straight edge of the load or alternatively to include a right angle to enable location about the upper corners of the load.

In another embodiment of the invention, as also illustrated within FIG. 1, a resilient layer 7 such as rubber or resilient plastics material is located beneath the members, preferably beneath both the side section 5 and upper section 8. The use of a resilient layer 7 beneath the members 2 will help prevent damage to the load which could occur as a result of contact with the members 2, and may also offer some slip resistance between the member and the load.

In FIG. 2 there is shown an example of a means by which a circular load 13 may be restrained on a platform. In the example shown in FIG. 2 the cylindrical load is placed on a pellet 12 such as a metal or wooden pellet, preferably with a layer of resilient material between the pellet 12 and the load 13. The presence of this resilient material will not only serve to minimise damage to the load and/or the pellet but provides a surface with a high coefficient of friction to prevent sliding of the load 13 off the pellet 12. Load retaining devices 1 according to the invention may for example be located at opposing sides of the load 13 with securing means 9 affixed to fastening points 10 and then running over the load 13 to be fixed to a second fastening point on an opposite side thereof. The securing means 9 will be positioned so as to provide a downward force on the members 2 as well as a lateral force within the load retaining devices 1. Ideally therefore the fastening points 10 will be located at a point on the tray bearing the load which is located laterally relative to the abutments 11 of the members 2 against which the securing means 9 will rest.

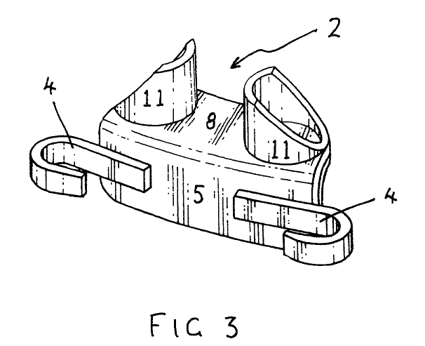

Another aspect of the invention is shown in FIG. 3. In this embodiment of the invention the member 2 comprises an upper section 8 having two abutments 11, located at either end of the upper section 8. In this embodiment there are also two attachment means 4 for connection to the spacer (not shown), which are located at either end of the side section 5. In the embodiment of the invention shown in FIG. 3 the attachment means 4 take the form of hooks that have been welded directly to the side section 5. There are of course various forms which the attachment means 4 can take. For example a hook or clasp that may engage a chain by locking between a link of the chain could be attached to the side section 5 by means of a bolt, such as that shown within FIG. 1.

The embodiment of the invention shown within FIG. 3 is a versatile member which allows interconnection to other members at one or both ends thereof and which has two abutments against which securing means can be located to exert a downward and lateral force, in order to stabilise the load. Of course it is not essential in use that securing means must be located against both of the abutments shown in this form of the invention. It is also possible that in use the member shown in FIG. 3 may be connected to itself via a single spacer that may pass around the entire circumference of the load, preferably just beneath an upper edge thereof.

It is to be understood that the present invention has been described by way of example only and that modifications and/or alterations thereto which would be apparent to a person skilled in the art based upon the disclosure herein are also considered to fall within the scope and spirit of the invention.

The claims defining the inventison are as follows:

1. A load restraining device comprising a plurality of members connected by a spacer or spacers and locatable about an upper edge of the load to be restrained; the members having upper and side sections with one or more abutments located on the upper section.

2. The load restraining device according to claim 1 wherein the distance between the members is fixed by the spacer or spacers.

3. The load restraining device according to claim 1 wherein the spacer or spacers allow adjustable distance setting between the members.

4. The load restraining device according to claim 3 wherein the spacer comprises chain connected to the members and a releasable catch for varying spacer length.

5. The load restraining device according to claim 1 comprising a pair of members connected by a single spacer.

6. The load restraining device according to claim 1 wherein the members have one or two abutments located on the upper section.

7. A method of restraining a load comprising locating a restraining device according to claim 1 about an upper edge of the load, fastening securing means to a first fastening point, passing the securing means over the load and against the abutments and fastening to a second securing point such that the securing means exert downward force on the load via the members and lateral force against the abutments.

8. The method according to claim 7 wherein the securing means is rope, strap, wire, cable or chain.

9. A component of a load restraining device comprising a member locatable about an edge of a load to be restrained; the member having an upper and a side section, with one or more abutments located on the upper section and with one or more means for connection to a spacer.

10. A component of a load restraining device comprising a member locatable about an edge of a load to be restrained; the member having an upper and a side section, with two abutments each located at or towards ends of the upper section and with two means for connection to a spacer each located at or towards ends of the side section.

11. The component according to claim 10 wherein the means for connection comprise hooks suitable for engaging between links of a spacer chain.

12. The component according to claim 10 wherein resilient material is located on surfaces of the member that in use will contact the load.
